(19) United States
(12) Patent Application Publication
(10) Pub. No.: US 2025/0062360 A1
(43) Pub. Date: Feb. 20, 2025

(54) BINDER FOR LITHIUM SECONDARY BATTERY AND ELECTRODE USING SAME FOR LITHIUM SECONDARY BATTERY

(71) Applicants: LG Energy Solution, Ltd., Seoul (KR); LX MMA CORP., Jeollanam-do (KR)

(72) Inventors: Taegon Kim, Daejeon (KR); Myeongsoo Kim, Daejeon (KR); Seong Jang Jeon, Daejeon (KR); Da Hyun Kang, Daejeon (KR); Sung Il Park, Daejeon (KR); Bubsung Kim, Daejeon (KR); Choonghyeon Lee, Daejeon (KR); Min Sang Song, Daejeon (KR)

(21) Appl. No.: 18/723,315

(22) PCT Filed: Aug. 21, 2023
(86) PCT No.: PCT/KR2023/012316

§ 371 Date: Jun. 21, 2024

(30) Foreign Application Priority Data
Sep. 15, 2022 (KR) 10-2022-0116479

(51) Int. Cl. H01M 4/62; C08L 27/18; C08L 33/12

(52) U.S. Cl. CPC H01M 4/623; C08L 27/18; C08L 33/12; C08L 2203/20; C08L 2207/53

(57) ABSTRACT

A binder includes composite particles with a polytetrafluoroethylene structure coated with an acrylic polymer. The binder can be for a lithium secondary battery according to one embodiment of the present invention, and not only can solve problems such as agglomeration that can occur when handling conventional binders, but also has excellent physical properties such as low thickness deviation and high tensile strength when manufacturing electrodes. In addition, a battery with these electrodes has improved performance, such as improved capacity retention rate.

### REFERENCE TO RELATED APPLICATIONS

The present application is a National Phase entry pursuant to 35 U.S.C. § 371 of International Application No. PCT/KR2023/012316 filed on Aug. 21, 2023, and claims priority to and the benefit of Korean Patent Application No. 10-2022-0116479 filed on Sep. 15, 2022, all contents of which are incorporated herein by reference as a part of the present specification.

### TECHNICAL FIELD

The present invention relates to a binder for a lithium secondary battery and an electrode for a lithium secondary battery using the same. Specifically, it relates to a binder for a lithium secondary battery comprising polytetrafluoroethylene modified with an acrylic polymer and an electrode for a lithium secondary battery using the same.

### BACKGROUND ART

As the technology development and the demand for mobile devices increase, the demand for secondary batteries as an energy source is rapidly increasing. Among secondary batteries, lithium secondary batteries with high energy density and voltage, long cycle life, and low self-discharge rate have been widely used commercially.

In the manufacture of an electrode for a lithium secondary battery, an electrode active material, a conductive material and a binder are mixed to prepare a mixture comprising an electrode active material. After applying the mixture to an electrode current collector, the mixture is pressurized using equipment such as a roll to produce an electrode. When a binder, such as polytetrafluoroethylene (PTFE), is pressurized by a roll, fiberization proceeds as the shear force is applied around the surface in contact with the roll. This fiberization is made in the direction of roll progression (Machine Direction (MD)), and relatively, is mostly formed around the binder on the surface of the electrode. Despite the fiberization of the binder, the electrode active material, the conductive material and the binder in the electrode are still present in the form of small particles, so the electrode may lack durability. The durability of an electrode can be related to the lifetime of the electrode, which can directly affect the performance of a battery.

As user demand for a secondary battery having high energy density is rapidly increasing, research on thicker electrodes (thick film electrodes) has been ongoing in the relevant technical field. The conventional methods of manufacturing an electrode by coating a slurry containing an electrode active material in a wet manner are accompanied by the migration of a conductive material and a binder to the top of the coating layer during drying, and accordingly, it is not easy to maintain the quality of the manufactured electrode while increasing the thickness of the electrode due to poor conductivity and low adhesion between the current collector and the electrode active material. Unless maximizing the functionality of the fiberized binder, even a novel method of manufacturing an electrode in a dry manner also lacks adhesion between the particles of the electrode active material, the conductive material and the binder, so that it is difficult to manufacture a durable electrode with high thickness.

Therefore, the inventor of the present invention completed the present invention after continuous research on a method of manufacturing a durable thick film electrode by increasing the functionality of the binder while using a dry method.

(Patent reference 1) Korean Patent Laid-open Publication No. 10-2014-0136952

### SUMMARY OF THE INVENTION

The present invention seeks to provide a binder, such as a binder for a lithium secondary battery, comprising polytetrafluoroethylene modified with an acrylic polymer, which is easy to handle and can improve the functionality of the battery when applied, and an electrode for a lithium secondary battery using same.

According to a first aspect of the present invention, a binder, such as a binder for a lithium secondary battery, comprising composite particles with a polytetrafluoroethylene structure coated with an acrylic polymer is provided.

In one embodiment of the present invention, the composite particles have an average diameter of from 0.01 μm to 2 μm.

In one embodiment of the present invention, the acrylic polymer is a polymer of monomers comprising alkyl acrylate, alkyl methacrylate or a combination thereof, wherein the alkyl is an alkyl having 1 to 10 carbon atoms.

In one embodiment of the present invention, the acrylic polymer has a glass transition temperature of 60° C. to 150° C.

In one embodiment of the present invention, the acrylic polymer has a weight average molecular weight of 10,000 g/mol to 300,000 g/mol.

In one embodiment of the present invention, the acrylic polymer is a copolymer of monomers comprising 40% to 90% by weight of methyl methacrylate, based on the total weight of the monomers.

In one embodiment of the present invention, the acrylic polymer is a copolymer of monomers comprising methyl methacrylate and n-butyl acrylate.

In one embodiment of the present invention, the acrylic polymer is coated on polytetrafluoroethylene in an amount of 5% to 40% by weight, based on the total weight of the composite particles.

In one embodiment of the present invention, the n-butyl acrylate is comprised in an amount of 10 parts to 60 parts by weight, based on 100 parts by weight of methyl methacrylate.

In one embodiment of the present invention, the monomer further comprises an acrylic acid or a methacrylic acid.

In one embodiment of the present invention, the acrylic acid or methacrylic acid is present in an amount of 0.1% to 40% by weight, based on the total weight of the monomers.

In one embodiment of the present invention, the polytetrafluoroethylene has a standard specific gravity (SSG) of 2.3 or less.

According to a second aspect of the present invention, an electrode for a lithium secondary battery prepared by mixing the above-mentioned binder, electrode active material and conductive material, and then pressing them is provided. In one embodiment of the present invention, the binder is present in an amount of 0.1% to 10% by weight in the electrode, based on the total weight of the binder, the electrode active material, and the conductive material. The binder for a lithium secondary battery according to one embodiment of the present invention can solve problems such as agglomeration that can occur during handling of conventional binders by modifying polytetrafluoroethylene with an acrylic polymer.

In addition, an electrode prepared using the binder has excellent physical properties, such as low thickness deviation and high tensile strength, and when the electrode is applied to a battery, performances of the battery, such as the capacity retention rate, can be improved.

### BRIEF DESCRIPTION OF THE DRAWINGS

FIG. 1 is TEM and TEM-EDX mapping images showing a composite particle binder having a polytetrafluoroethylene structure coated with an acrylic polymer, according to one embodiment of the present invention.

### DETAILED DESCRIPTION

All of the embodiments provided by the present invention can be achieved by the following description. It is to be understood that the following description describes preferred embodiments of the present invention, but the present invention is not necessarily limited thereto.

For properties described in this specification, where measurement conditions and methods are not specifically described, the properties are measured according to measurement conditions and methods commonly used by those skilled in the art.

The present invention provides a binder for a lithium secondary battery, which is a binder comprising polytetrafluoroethylene modified with an acrylic polymer. Polytetrafluoroethylene, which is commonly used in the relevant art as a binder when electrodes are manufactured by a dry method, is a long chain polymer, and maintains a stable phase below the phase transition temperature of 19° C. Whereas, at room temperature exceeding 19° C., the twisted helical chains are easily unwound and fiberization easily proceeds, so polytetrafluoroethylene is characterized by having a mutual aggregation even when a small shear force is applied. In particular, since at room temperature of around 25° C. exceeds the phase transition temperature of 19° C., the powder is easily microfibrillated and agglomerated even when powder transportation and stirring where a shear force can be applied from time to time, the powder is not easily dispersed uniformly in the process of manufacturing an electrode in a dry manner. Therefore, polytetrafluoroethylene requires high maintenance costs for refrigerated transportation and refrigerated storage during handling, and special attention to the working temperature is required. To solve the problem of polytetrafluoroethylene, the present invention modifies polytetrafluoroethylene with an acrylic polymer.

Various methods for modifying the polytetrafluoroethylene with an acrylic polymer may exist. In one embodiment of the present invention, the outside of the polytetrafluoroethylene particle is coated with an acrylic polymer to provide a composite particle with an acrylic polymer/polytetrafluoroethylene structure. The composite particle may also be represented by a core-shell structure, wherein the core is composed of polytetrafluoroethylene and the shell is composed of an acrylic polymer.

According to one embodiment of the present invention, coating polytetrafluoroethylene particles with an acrylic polymer can eliminate the problem of agglomeration of polytetrafluoroethylene, so that a polymeric material with a high degree of fiberization can be used for the polytetrafluoroethylene contained therein. According to one embodiment of the present invention, the polytetrafluoroethylene has a standard specific gravity (SSG) of 2.3 or less. The standard specific gravity is defined by a measurement method according to Japanese Industrial Standard (JIS) K6892. Since the standard specific gravity is negatively correlated with the average molecular weight, a lower standard specific gravity of the polytetrafluoroethylene means a higher molecular weight thereof. Considering that the higher the molecular weight, the better the degree of fiberization, the lower limit of the standard specific gravity range may not be very important, but may be, for example, 2.0 or more. Since polytetrafluoroethylene is more easily handled, the composite particles according to one embodiment of the present invention can reduce the standard specific gravity as much as possible.

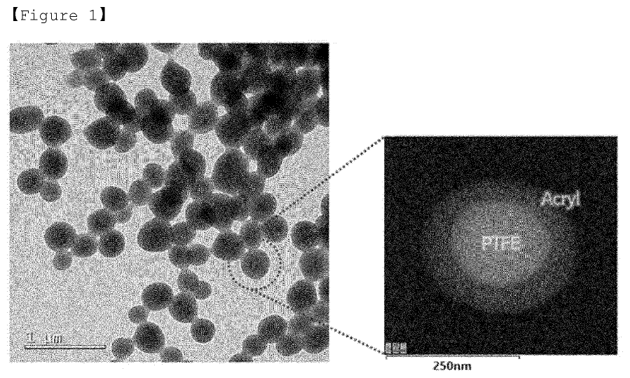

FIG. 1 provides Transmission Electron Microscope (TEM) and Energy Dispersive X-ray Spectroscopy (TEM-EDX) mapping images depicting a composite particle binder having a polytetrafluoroethylene structure coated with an acrylic polymer, according to one embodiment of the present invention. As shown in FIG. 1, in polytetrafluoroethylene coated with an acrylic polymer, the polytetrafluoroethylene particles do not agglomerate with each other due to the acrylic polymer located on the outside, and the core-shell composite particles can be easily separated while retaining their original shape. These composite particles are highly dispersible when mixed with an electrode active material and a conductive material in an electrode active material layer, which can increase the efficiency of binder application by fiber formation even with a small amount.

According to one embodiment of the present invention, the composite particles have an average diameter of from 0.01 μm to 2 μm. The average diameter was obtained by measuring the size of each particle distinguishable in the TEM analysis image, and then calculating the arithmetic mean value thereof. Specifically, the average diameter of the composite particles may be 0.01 μm to 2 μm, 0.01 μm to 1.5 μm, or 0.01 μm to 1 μm. Such an average diameter of the composite particles helps to increase the dispersibility of the composite particles in the electrode active material layer while making the polytetrafluoroethylene fibered to an appropriate level.

Since the polytetrafluoroethylene can easily agglomerate at room temperature, it may not be easy to control the particle size when manufacturing the composite particles because of this agglomeration. Therefore, for convenience of operation, the composite particles are prepared by adding a dispersant, uniformly dispersing the polytetrafluoroethylene and then coating an acrylic polymer. Due to the characteristics of the manufacturing method, traces of dispersant may be detected between the polytetrafluoroethylene and the acrylic polymer. However, the polytetrafluoroethylene, which is the core, and the acrylic polymer, which is the shell, are not necessarily strongly bonded, and even if the bond between the core and the shell is not high due to the presence of the dispersant, it is advantageous that the core component can be more easily released in the event of melting/fracturing of the shell. The dispersant may be, but is not particularly limited to, any substance commonly used in the art that does not readily undergo side reactions with polytetrafluoroethylene and an acrylic polymer. For example, an ethylene glycol-based non-ionic surfactant may be used as the dispersant, in particular, Tween 20, Tween 60, Tween 80, Brij L23, Brij 020, triton x-100, tergitol 100X.

In the composite particles, the acrylic polymer is not particularly limited, provided that it can form a coating layer to prevent agglomeration of polytetrafluoroethylene. According to one embodiment of the present invention, the acrylic polymer is a polymer of monomers comprising alkyl acrylate, alkyl methacrylate or a combination thereof. The alkyl acrylate and alkyl methacrylate polymerization units in the acrylic polymer may be 20 mol % or more, 50 mol % or more, or 70 mol % or more. Here, the alkyl may be adjusted to a suitable level in consideration of the properties of the coating layer, and in one embodiment of the present invention, an alkyl having 1 to 10 carbon atoms is used. The alkyl may be a linear or branched substituent, and may be a substituted or unsubstituted alkyl. The functional group replacing the alkyl is not particularly limited as long as it is commonly used in the art, and it may be preferable that it is not highly reactive in relation to other components of the electrode active layer, for example, an alkyl functional group such as methyl or ethyl, a halogen functional group such as fluorine, a hydroxyl functional group, an alkoxy functional group such as methoxy or ethoxy, an epoxy functional group, and the like may be used.

According to one embodiment of the present invention, the acrylate-based monomer forming the acrylic polymer is selected from the group consisting of methyl acrylate, ethyl acrylate, propyl acrylate, isopropyl acrylate, butyl acrylate, 2-ethylhexyl acrylate, cyclohexyl acrylate, glycidyl acrylate, and combinations thereof. The methacrylate-based monomer forming the acrylic polymer is selected from the group consisting of methyl methacrylate, ethyl methacrylate, propyl methacrylate, isopropyl methacrylate, butyl methacrylate, 2-ethylhexyl methacrylate, cyclohexyl methacrylate, glycidyl methacrylate, and combinations thereof. The acrylate-based monomer and the methacrylate-based monomer may be used in combination.

The acrylic polymer may comprise one or more monomers, and if the monomers are two or more alkyl acrylates or alkyl methacrylates, it may be a copolymer. Thus, the term “polymer” used herein can be interpreted to include a copolymer. The acrylic polymer is formed by linking monomers by breaking the double bonds present in the acrylic monomers into single bonds, so that the structure of the monomers in the polymer remains substantially intact. Although the arrangement of the monomers in the copolymer is not necessarily limited to any one of random, alternating and block copolymers, random copolymers may be usually used.

The acrylic polymer is a coating layer that prevents agglomeration of polytetrafluoroethylene, and has the function of keeping polytetrafluoroethylene stable inside the coating layer until the polytetrafluoroethylene becomes fibrous through heating or pressurization by having a certain level of durability without agglomeration between different particles. Furthermore, the acrylic polymer may have the function of reinforcing the adhesion between the components in the dry electrode. The acrylic polymer may be adjusted to a certain level of physical properties in order to have the functions described above.

According to one embodiment of the present invention, the acrylic polymer has a glass transition temperature of 60° C. to 150° C. The glass transition temperature is measured according to the conventional measurement method using DSC (Differential Scanning calorimeter) equipment (e.g., Q20 manufactured by TA). Specifically, the glass transition temperature of the acrylic polymer is 60°° C. to 150°° C., 65° C. to 140°° C., 70° C. to 130° C., or 75° C. to 120°° C. An acrylic polymer having a glass transition temperature within the above ranges may have better functionality.

The weight average molecular weight of the acrylic polymer can also affect functionality. According to one embodiment of the present invention, the acrylic polymer has a weight average molecular weight of 10,000 g/mol to 600,000 g/mol. The weight average molecular weight is obtained by converting the value of a standard polymethylmethacrylate as measured by a Gel Permeation Chromatograph (GPC) equipment (e.g., Alliance2695 manufactured by Waters). Specifically, the acrylic polymer has a weight average molecular weight of 10,000 g/mol to 600,000 g/mol, 10,000 g/mol to 300,000 g/mol, or 100,000 g/mol to 200,000 g/mol. An acrylic polymer having a weight average molecular weight within the above ranges may have better functionality.

The properties that affect the functionality of the acrylic polymer can be controlled by adjusting the composition of the monomers constituting the polymer. The methyl methacrylate may be the main monomer constituting an acrylic polymer, which accounts for the largest portion of the polymer. According to one embodiment of the present invention, the acrylic polymer is a copolymer of monomers comprising 40% to 90% by weight of methyl methacrylate, based on the total weight of the monomers. Specifically, the content of the methyl methacrylate may be 40% to 90% by weight, or 45% to 90% by weight. By combining different types of monomers on the basis of the methyl methacrylate, the properties of the acrylic polymer can be adjusted.

The methyl methacrylate can be combined with any acrylate or methacrylate monomers, other than methyl methacrylate, to prepare various kinds of acrylic polymers. According to one embodiment of the present invention, the acrylic polymer is a copolymer of monomers comprising methyl methacrylate and n-butyl acrylate. The n-butyl acrylate contains an n-butyl group which is different from methyl methacrylate in the number of carbon atoms by three, which can be easily adjusted to have the properties required by the present invention, even with a small amount, compared to other alkyl acrylates. According to one embodiment of the present invention, the n-butyl acrylate comprises 10 parts to 60 parts by weight based on 100 parts by weight of methyl methacrylate. When the compound is polymerized with methyl methacrylate within the above range, more preferable properties can be obtained.

The acrylic polymer may further comprise novel functional groups to provide additional functionality, such as enhancing cohesion between the components in the dry electrode even after the composite particles are destroyed by heating or pressurization to release the polytetrafluoroethylene therefrom. Such functional groups may be introduced into the acrylic polymer from monomers other than alkyl acrylate or alkyl methacrylate, and the functional groups may be carboxylic acids. According to one embodiment of the present invention, the monomers consisting of the acrylic polymer further comprise an acrylic acid or a methacrylic acid.

According to one embodiment of the present invention, the acrylic acid or methacrylic acid is present in an amount of 40 wt % or less, based on the total weight of the monomers. In specific, the content of the acrylic acid or methacrylic acid may be 40% or less by weight, or 30% or less by weight. The acrylic acid or methacrylic acid is an optional component, not an essential component, in that it is introduced to provide the additional functionality described above, and therefore, the lower limit of the content may include 0% by weight. However, if the acrylic acid or methacrylic acid is included to provide additional functionality, the acrylic acid or methacrylic acid may be present in the acrylic polymer in an amount ranging from a very small amount of 0.1% or more by weight to the upper limit described above, for example, 0.1% to 40% by weight, 5% to 35% by weight, or 10% to 30% by weight. The acrylic acid or methacrylic acid can increase the adhesion to an electrode active material or a conductive material constituting the electrode as well as polytetrafluoroethylene due to the carboxylic acid projecting outwardly from the coating layer.

Since the acrylic polymer does not have the characteristic of being easily fibrous like polytetrafluoroethylene, it cannot replace polytetrafluoroethylene as a binder. Therefore, the acrylic polymer is not required in large amounts, provided that the functionality described above is achieved. According to one embodiment of the present invention, 5% to 40% by weight of the acrylic polymer is coated on polytetrafluoroethylene, based on the total weight of the composite particles. The content of the acrylic polymer may be 5% to 40% by weight, 10% to 30% by weight, or 10% to 20% by weight. Within the above ranges, a sufficient amount of polytetrafluoroethylene can be present while achieving the purpose of introducing the acrylic polymer.

In the manufacture of electrodes for a lithium secondary battery, considering the processability of a mixture comprising an electrode active material, a wet method is usually used, in which a solvent such as water or an organic solvent is added to the mixture, and the mixture is applied to an electrode current collector in the form of a slurry. However, it is difficult to increase the thickness of the electrode due to problems such as migration of the binder during drying and low adhesion between the electrode current collector and the electrode active material. In order to solve these problems, research has been conducted on a solvent-free dry method for manufacturing electrodes, and polytetrafluoroethylene has been utilized as a binder as a means of solving the problem of poor cohesion of an electrode active material, a conductive material and a binder during the dry method. The present invention improves the utilization value of a polytetrafluoroethylene binder by modifying it with an acrylic polymer, and specifically relates to a dry method of manufacturing electrodes for a lithium secondary battery.

According to the dry method, an electrode for a lithium secondary battery is prepared by mixing and dispersing an electrode active material, a conductive material and a binder, followed by pressurization. As the binder, a composite particle binder according to one embodiment of the present invention is utilized. The electrode may consist of an active layer and a current collector, wherein the active layer is a layer comprising an electrode active material, a conductive material and a binder. The current collector not only supports the active layer, but also supplies electrons to the active layer, but the current collector may not necessarily be comprised depending on the active layer. The active layer is active in the electrochemical reaction in the electrode because it contains an electrode active material, and the active layer can be described as an electrode active layer in that it contains an electrode active material, or a mixed layer in that it is formed by mixing an electrode active material, a conductive material and a binder. In addition, in the case of all-solid-state batteries, which have been the subject of intense research in recent years, a battery may further comprise a solid electrolyte.

The electrode active material may be a positive electrode active material when applied to a positive electrode, or a negative electrode active material when applied to a negative electrode. The positive electrode active material or negative electrode active material is not particularly limited as long as it is commonly used in the art.

According to one embodiment of the present invention, the positive electrode active material is a lithium transition metal oxide. In the lithium transition metal oxide, the transition metal has the form of Li₁₊ₓM_{y}O_{2+z} (wherein 0≤x≤5, 0<y≤2, and 0≤z≤2), wherein M is selected from the group consisting of, but not particularly limited to, Ni, Co, Mn, Fe, P, Al, Mg, Ca, Zr, Zn, Ti, Ru, Nb, W, B, Si, Na, K, Mo, V, and combinations thereof. More specifically, the lithium transition metal oxide is selected from the group consisting of LiCoO₂, LiNiO₂, LiMnO₂, Li₂MnO₃, LiMnO₄, Li(NiₐCo_{b}Mn_{c})O₂ (0<a<1, 0<b<1, 0<c<1, a+b+c=1), LiNi_{1-y}Co_{y}O₂ (0<y<1), LiCo_{1-y}Mn_{y}O₂ (0<y<1), LiNi_{1-y}Mn_{y}O₂ (0<y<1), Li(NiₐCo_{b}Mn_{c}) O₄ (0<a<2, 0<b<2, 0<c<2, a+b+c=2), LiMn_{2-z}Ni_{z}O₄ (0<z<2), LiMn_{2-z}Co_{z}O₄ (0<z<2) , and combinations thereof.

According to one embodiment of the present invention, the negative electrode active material is a compound capable of reversible intercalation and deintercalation of lithium. Specific examples include a carbonaceous material such as artificial graphite, natural graphite, graphitized carbon fiber, amorphous carbon, etc.; a metallic compound capable of alloying with lithium such as Si, Al, Sn, Pb, Zn, Bi, In, Mg, Ga, Cd, Si alloys, Sn alloys, or Al alloys; a metal oxide capable of doping and de-doping lithium, such as SiO_{β} (wherein 0<β<2), SnO₂, vanadium oxide, or lithium vanadium oxide; or a composite including the metallic compound and the carbonaceous material, such as a Si—C composite or Sn—C composite, and any one or more mixtures thereof may be used. Also, a metallic lithium thin film may be used as the negative electrode active material. Furthermore, both low-crystalline carbon and high-crystalline carbon can be used as the carbon material. Low-crystalline carbons include soft carbon and hard carbon, and high-crystalline carbons include natural or artificial graphite in amorphous, plate, in-plane, spherical, or fibrous form, and Kish graphite, pyrolytic carbon, mesophase pitch based carbon fiber, meso-carbon microbeads, mesophase pitches, and high temperature calcined carbons such as petroleum or coal tar pitch derived cokes. In addition, metal nanoparticles having lithiophilic properties can be further included. Such metal nanoparticles may be a combination of one or more selected from silver, gold, platinum, palladium, silicon, aluminum, bismuth, tin, indium, zinc, and the like, and may be specifically silver.

According to one embodiment of the present invention, the electrode active material is a lithium transition metal oxide having an average diameter of 5 μm to 30 μm of particles. In specific, the average diameter of the particles is 5 μm or more, 6 μm or more, 7 μm or more, 8 μm or more, 9 μm or more, 10 μm or more, 30 μm or less, 28 μm or less, 26 μm or less, 24 μm or less, 22 μm or less, or 20 μm or less, and may be 5 μm to 30 μm, 7 μm to 24 μm, or 10 μm to 20 μm.

The conductive material is used to provide conductivity to electrodes, and can be used without any particular limitation, provided that it is electronically conductive without causing any chemical changes when manufacturing a battery. Specific examples include graphite, such as natural or artificial graphite; carbon-based materials such as carbon black, acetylene black, Ketjen black, channel black, furnace black, lamp black, summer black, single-walled or multi-walled carbon nanotubes, carbon fiber, carbon nanofiber, graphene, activated carbon, or activated carbon fiber; metal powders or metal fibers, such as copper, nickel, aluminum or silver; conductive whiskers, such as zinc oxide or potassium titanate; conductive metal oxides, such as titanium oxide; or conductive polymers, such as polyphenylene derivatives, any one of which may be used alone or in a mixture of two or more.

The conductive material may be a carbon-based material or a metallic material, wherein the metallic material may include metal powders, metal fibers, or conductive metal oxides as described above. The conductive material may be spherical or linear particles. When the conductive material consists of spherical particles, the average diameter of the particles may be 1 nm to 100 nm, particularly 5 nm to 70 nm, more particularly 10 nm to 40 nm. If the conductive material consists of linear particles, the length of the particles may be 1 μm to 10 μm, particularly 2 μm to 9 μm, more particularly 3 μm to 8 μm, and the diameter of the vertical section may be 10 nm to 500 nm, particularly 50 nm to 350 nm, more particularly 100 nm to 200 nm.

The binder improves the adhesion between the electrode active material particles and the adhesion of the electrode active material to the electrode current collector. In one embodiment of the present invention, the composite particles are used as a binder, and the composite particles that do not easily agglomerate are mixed with the electrode active material and the conductive material to be uniformly dispersed. The composite particles are then fibered and pressed by equipment such as a roll, in which the acrylic polymer coating layer is destroyed to release polytetrafluoroethylene therefrom, and becomes fiberized by an applied shear force. Due to the good dispersibility of the composite particles in the active layer, the present invention can maximize the functionality of the binder. The acrylic polymer coating layer can also be destroyed by heating, so that when mixing by heating, polytetrafluoroethylene can be fibered simultaneously with mixing.

According to one embodiment of the present invention, the binder is comprised in an amount of 0.1% to 10% by weight, particularly 0.5% to 5% by weight, and more particularly 1% to 3% by weight in the active layer, based on the total weight of the electrode active material, the conductive material and the binder. The present invention is significant in that the cohesion of the entire active layer can be improved even with a small amount of binder.

The electrodes according to one embodiment of the present invention not necessarily require an electrode current collector in that the shape of the electrodes can be fixed due to fibrosis of a binder, but an electrode current collector can be utilized in that the electrodes can be a uniform pathway for electrons in the relationship between the wire and the active layer of the battery. The electrode current collector is not particularly limited as long as it is conductive without causing any chemical changes to a battery, and for example, stainless steel, aluminum, nickel, titanium, calcined carbon, or aluminum or stainless steel surface treated with carbon, nickel, titanium or silver may be used. Furthermore, the electrode current collector may have a thickness of typically 3 μm to 500 μm, and fine irregularities may be formed on the surface of the electrode current collector to increase the adhesion of the electrode active material. For example, it can be used in various forms such as film, sheet, foil, net, porous material, foam, non-woven material, etc. Additionally, the electrode current collector may be a primer coated foil, wherein the current collector material may include a surface layer coated with a mixture of a conductive carbon material and a binder.

The electrodes can be applied to a lithium secondary battery. The lithium secondary battery is typically manufactured by interposing a separating film between the positive electrode and the negative electrode, and then injecting electrolyte, but can be modified in various ways, such as by mixing solid electrolytes as needed.

The separating film, which separates the negative electrode from the positive electrode and provides a migration passage for lithium ions, can be used without special limitation as long as it is used as a separating film in a conventional lithium secondary battery, and it is preferable to have a low resistance to ion migration of the electrolyte and an excellent ability to moisten the electrolyte. In specific, a porous polymeric film, for example, a porous polymeric film made of a polyolefin-based polymer such as an ethylene homopolymer, a propylene homopolymer, an ethylene/butene copolymer, an ethylene/hexene copolymer or an ethylene/methacrylate copolymer, or a laminated structure of two or more layers thereof, may be used. Conventional porous nonwoven fabrics may also be used, for example, nonwoven fabrics made of high melting point glass fibers or polyethylene terephthalate fibers. In addition, a coated separating film containing a ceramic component or a polymeric material for securing heat resistance or mechanical strength may be used, optionally in a single-layer or multi-layer structure.

The electrolytes include, but are not limited to, liquid electrolytes and solid electrolytes that can be used in the manufacture of a lithium secondary battery.

For example, the liquid electrolyte may include an organic solvent and a lithium salt.

The organic solvent can be used without any particular limitation as long as it can serve as a medium through which the ions involved in the electrochemical reaction of the battery can move. Specifically, the organic solvent includes an ester-based solvent such as methyl acetate, ethyl acetate, γ-butyrolactone, or ε-caprolactone; an ether-based solvent, such as dibutyl ether or tetrahydrofuran; a ketone-based solvent, such as cyclohexanone; an aromatic hydrocarbon-based solvent, such as benzene or fluorobenzene; a carbonate-based solvent such as dimethylcarbonate (DMC), diethylcarbonate (DEC), methylethylcarbonate (MEC), ethylmethylcarbonate (EMC), ethylene carbonate (EC), or propylene carbonate (PC); an alcohol-based solvent, such as ethyl alcohol, or isopropyl alcohol; nitriles, such as R-CN (where R is a straight, branched, or cyclic hydrocarbon group having 2 or 20 carbon atoms, and may include a double bonded aromatic or ether bond); amides, such as dimethylformamide; dioxolanes, such as 1,3-dioxolane; or sulfolanes. Among these solvents, a carbonate-based solvent is preferred, and a mixture of a cyclic carbonate (e.g., ethylene carbonate or propylene carbonate) having a high ionic conductivity and a high dielectric constant that can increase the charge and discharge performance of the battery and a linear carbonate-based compound (e.g., ethyl methyl carbonate, dimethyl carbonate or diethyl carbonate) having a low viscosity is more preferred.

In this case, a mixture of cyclic carbonate and chained carbonate in a volume ratio of about 1:1 to about 1:9 may result in a superior performance of the electrolyte.

The lithium salts may be used without any limitation as long as they are compounds capable of providing lithium ions for use in a lithium secondary battery. In specific, the lithium salts may be LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃), LiN(C₂F₅SO₂)₂, LiN(CF₃SO₂)₂, LiCl, LiI or LiB(C₂O₄)₂. Preferably, the concentration of the lithium salts is in the range of 0.1 to 2.0 M. When the concentration of the lithium salts is within the above range, the electrolyte has suitable conductivity and viscosity, so that it can exhibit good electrolyte performance, and the lithium ions can be effectively transported.

In addition to the above electrolyte components, the electrolyte may also contain, for example, one or more additives such as haloalkylene carbonate-based compounds such as difluoroethylene carbonate, pyridine, triethylphosphite, triethanolamine, cyclic ether, ethylenediamine, N-glyme, hexaphosphate triamide, nitrobenzene derivatives, sulfur, quinone imine dyes, N-substituted oxazolidinones, N,N-substituted imidazolidines, ethylene glycol dialkyl ether, ammonium salts, pyrroles, 2-methoxyethanol, or aluminum trichloride for the purpose of improving the life characteristics of the battery, inhibiting the reduction of the battery capacity, and improving the discharge capacity of the battery. The additives may be comprised in an amount of 0.1% to 5% by weight, based on the total weight of the electrolyte.

In that the electrodes according to one embodiment of the present invention are manufactured in a dry manner, a solid electrolyte may also be preferably used. The solid electrolyte may comprise an ionically conductive solid electrolyte material. The ionically conductive solid electrolyte material may comprise one or more of a polymeric solid electrolyte and an inorganic solid electrolyte. The polymeric solid electrolyte may comprise a polymeric resin and a lithium salt, and may be a solid polymeric electrolyte in the form of a mixture of a solvated lithium salt and a polymeric resin, or a polymeric gel electrolyte in which an organic electrolyte containing an organic solvent and a lithium salt is comprised in a polymeric resin. Hereinafter, without providing the duplicate description of the liquid electrolyte, the ionically conductive solid electrolyte material is described in detail.

The solid polymeric electrolyte comprises a polymeric resin, and may comprise one or more materials selected from the group consisting of, but not necessarily limited to, polyether-based polymers, polycarbonate-based polymers, acrylate-based polymers, polysiloxane-based polymers, phosphazene-based polymers, polyethylene derivatives, alkylene oxide derivatives, phosphate ester polymers, poly agitation lysine, polyester sulfides, polyvinyl alcohol, polyvinylidene fluoride, and polymers comprising ionic dissociation groups. Furthermore, the solid polymer electrolyte may comprise one or more materials selected from the group consisting of, but not necessarily limited to, a branched copolymer obtained by copolymerizing an amorphous polymer such as PMMA, polycarbonate, polysiloxane (PDMS), and/or phosphazene with a comonomer in a poly ethylene oxide (PEO) main chain, a comb-like polymer, and a cross-linked polymer resin.

The polymeric gel electrolyte comprises an organic electrolyte comprising a lithium salt and a polymeric resin, wherein the organic electrolyte may comprise 60 to 400 parts by weight of the polymeric resin. Polymeric resins applicable to the gel electrolyte, for example, may be one or more materials selected from the group consisting of, but not necessarily limited to, polyvinyl chloride (PVC), poly(methyl methacrylate) (PMMA), polyacrylonitrile (PAN), polyvinylidene fluoride (PVdF), and polyvinylidene fluoride-hexafluoropropylene (PVdF-HFP).

The inorganic solid electrolyte may comprise a sulfide-based solid electrolyte, a halide-based solid electrolyte, an oxide-based solid electrolyte, or one or more thereof.

The sulfide-based solid electrolyte includes a sulfur atom among the electrolyte components, but are not limited to any particular component, and may include one or more of crystalline solid electrolytes, amorphous solid electrolytes (glassy solid electrolytes), and glass-ceramic solid electrolytes. Specific examples of the sulfide-based solid electrolytes include, but are not necessarily limited to, LPS-type sulfides comprising sulfur and phosphorus, Li₄₋ₓGe₁₋ₓPₓS₄ (wherein x is 0.1 to 2, specifically x is ¾ or ⅔), Li_{10±1}MP₂X₁₂ (wherein M is Ge, Si, Sn or Al, and X is S or Se), Li_{3.833}Sn_{0.833}AS_{0.166}S₄, Li₄SnS₄, Li_{3.25}Ge_{0.25}P_{0.75}S₄, Li₂S—P₂S₅, B₂S₃—Li₃S, xLi₂S—(100—x)P₂S₅ (wherein x is 70 to 80), Li₂S—SiS₂—Li₃N, Li₂S—P₂S₅—LiI, Li₂S—SiS₂—LiI or Li₂S—B₂S₃—LiI.

The halide-based solid electrolyte may include, but is not necessarily limited to, at least one of Li₃YCl₆ and Li₃YBr₆. The oxide-based solid electrolytes may be suitably selected from and used, for example, but not necessarily limited to, LLTs with a perovskite structure such as Li₃ₓLa_{2/3-x}TiO₃, LISICONs such as Li₁₄Zn(GeO₄)₄, LATPs such as Li_{1.3}Al_{0.3}Ti_{1.7}(PO₄)₃, LAGPs such as (Li₁₊ₓGe₂₋ₓAlₓ(PO₄)₃), or phosphate-based such as LiPONs.

As described above, the lithium secondary battery comprising the electrode according to the present invention exhibits excellent discharge capacity, output characteristics, and capacity retention rate in a stable manner, and is therefore useful in portable devices such as mobile phones, notebook computers, digital cameras, and electric vehicles such as hybrid electric vehicles (HEVs).

According to another aspect of the present invention, a battery module comprising the lithium secondary battery as a unit cell and a battery pack comprising same are provided.

The battery module or battery pack may be used in, but is not necessarily limited to, power tools; electric vehicles including an electric vehicle (EV), a hybrid electric vehicle, and a plug-in hybrid electric vehicle (PHEV); electric two-wheelers including an electric bicycle (E-bike) and an electric scooter; electric golf carts; urban air mobilities (UAM); or power storage systems.

Hereinafter, Examples are presented to facilitate an understanding of the present invention. The following Examples are provided to illustrate the present invention, but the present invention is not limited thereto.

### EXAMPLES

### Preparation Examples (Preparation of Composite Particles)

### Preparation Example 1: Using an Acrylic Polymer Polymerized With 100% by Weight of methyl methacrylate Monomers

A polytetrafluoroethylene aqueous dispersion (DISP30 manufactured by Chemours) with an average particle diameter of 0.22 μm, a solids concentration of 60%, and a standard specific gravity (SSG) of 2.22 after sintering was prepared.

Then, 1020.0 g of polytetrafluoroethylene aqueous dispersion and 1843.4 g of distilled water were added to a 4 L reactor, stirred at a speed of 350 RPM, and heated to 75° C. while nitrogen bubbling. After reaching the polymerization temperature of 75° C., the nitrogen bubbling was stopped, and after 15 minutes, 153 g of methyl methacrylate (MMA) was added to the reactor dropwise over 15 minutes. Fifteen minutes after the monomer was added, an aqueous solution of 10 g distilled water and 0.77 g ammonium persulfate was added to the reactor dropwise over approximately 10 minutes. The polymerization reaction proceeded for 4 hours from the end of the ammonium persulfate addition and then the mixture was cooled to 30° C. to obtain a white emulsion.

The white, polymerized emulsion was diluted 1,000-fold and analyzed for size using NICOMP 380 (manufactured by Entegris, Dynamic Light Scattering) and listed in Table 1 below. For structural analysis of the particles, a drop of the emulsion diluted in water was placed on a grid for a transmission electron microscope (TEM) and dried at room temperature. The structure of the dried sample was analyzed using a TEM/EDS (TECNAI TF20 manufactured by FEI) with an acceleration voltage of 200 kV and is shown in FIG. 1.

Further, the emulsion was lyophilized under the condition of −60° C. and 10 mTorr for 72 hours to obtain a white powder.

In the manner described above, an acrylic polymer polymerized with 100% by weight of methyl methacrylate monomer, a material constituting the exterior of the composite particles, having a weight average molecular weight (M_{w}) of 543,000 g/mol, and a glass transition temperature (T_{g}) of 120.2° C. was coated on polytetrafluoroethylene, a material constituting the interior of the composite particles, to prepare composite particles having an average diameter of 0.3 μm. The weight ratio of polytetrafluoroethylene and an acrylic polymer in the prepared composite particles was 80:20.

### Preparation Example 2: Using an acrylic Polymer Polymerized With 90% by Weight of methyl methacrylate and 10% by Weight of n-butyl acrylate Monomer

Except that a mixed monomer of 137.7 g of methyl methacrylate and 15.3 g of n-butyl acrylate, and 0.21 g of the chain mover n-octylmercaptan were applied, the same method as Preparation Example 1 was used.

In the manner described above, an acrylic polymer polymerized with 90% by weight of methyl methacrylate and 10% by weight of n-butyl acrylate monomer constituting the exterior of the composite particles (having a weight average molecular weight (M_{w}) of 182,000 g/mol, and glass transition temperature (T_{g}) of 101.4° C.) was coated on polytetrafluoroethylene, the same material constituting the interior of the composite particles as Preparation Example 1, to prepare composite particles (having an average diameter of the particles of 0.3 μm, and a weight ratio of polytetrafluoroethylene and the acrylic polymer of 80:20).

### Preparation Example 3: Using an acrylic Polymer Polymerized With 80% by Weight of methyl methacrylate and 20% by Weight of n-butyl acrylate Monomer

Except that a mixed monomer of 122.4 g of methyl methacrylate and 30.6 g of n-butyl acrylate, and 0.21 g of the chain mover n-octylmercaptan were applied, the same method as Preparation Example 1 was used.

In the manner described above, an acrylic polymer polymerized with 80% by weight of methyl methacrylate and 20% by weight of n-butyl acrylate monomer constituting the exterior of the composite particles (having a weight average molecular weight (M_{w}) of 193,000 g/mol, and a glass transition temperature (T_{g}) of 79.4° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

### Preparation Example 4: Using an acrylic Polymer Polymerized With 70% by Weight of methyl methacrylate and 30% by Weight of n-butyl acrylate Monomer

Except that a mixed monomer of 107.1 g of methyl methacrylate and 45.9 g of n-butyl acrylate, and 0.37 g of the chain mover n-octylmercaptan were applied, the same method as Preparation Example 1 was used.

In the manner described above, an acrylic polymer polymerized with 70% by weight of methyl methacrylate and 30% by weight of n-butyl acrylate monomer constituting the exterior of the composite particles (having a weight average molecular weight (M_{w}) of 128,000 g/mol, and a glass transition temperature (T_{g}) of 54.4° C.), was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

### Preparation Example 5: Using an Acrylic Polymer Polymerized With 50% by Weight of Methyl Methacrylate and 50% by Weight of Methacrylic Acid Monomer

Except that mixed monomer of 76.5 g of methyl methacrylate, 76.5 g of methacrylic acid, and 0.21 g of the chain mover n-octylmercaptan were applied, the same method as Preparation Example 1 was used.

In the manner described above, an acrylic polymer polymerized with 50% by weight of methyl methacrylate and 50% by weight of methacrylic acid monomer constituting the exterior of the composite particles (having a weight average molecular weight (M_{w}) of 188,000 g/mol, and a glass transition temperature (T_{g}) of 140.4° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

### Preparation Example 6: Using an acrylic Polymer Polymerized With 70% by Weight of methyl methacrylate and 30% by Weight of methacrylic Acid Monomer

Except that a mixed monomer of 107.1 g of methyl methacrylate and 45.9 g of methacrylic acid, and 0.21 g of the chain mover n-octylmercaptan were applied, the same method as Preparation Example 1 was used.

In the manner described above, an acrylic polymer polymerized with 70% by weight of methyl methacrylate and 30% by weight of methacrylic acid monomer constituting the exterior of the composite particles (having a weight average molecular weight (M_{w}) of 203,000 g/mol, and a glass transition temperature (T_{g}) of 131.2° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

### Preparation Example 7: Using an acrylic Polymer Polymerized With 90% by Weight of methyl methacrylate and 10% by Weight of methacrylic Acid Monomer

Except that a mixed monomer of 137.1 g of methyl methacrylate and 15.3 g of methacrylic acid, and 0.21 g of the chain mover n-octylmercaptan were applied, the same method as Preparation Example 1 was used.

In the manner described above, an acrylic polymer polymerized with 90% by weight of methyl methacrylate and 10% by weight of methacrylic acid monomer constituting the exterior of the composite particles (having a weight average molecular weight (M_{w}) of 211,000 g/mol, and a glass transition temperature (T_{g}) of 122.4° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

### Preparation Example 8: Using an acrylate Polymerized With 45% by Weight of methyl methacrylate, 25% by Weight of n-butyl acrylate, and 30% by Weight of methacrylic Acid Monomer

Except that a mixed monomer of 68.85 g of methyl methacrylate, 38.25 g of n-butyl acrylate and 45.9 g of methacrylic acid, and 0.28 g of the chain mover n-octylmercaptan were applied, the same method as Preparation Example 1 was used.

In the manner described above, an acrylic polymer polymerized with 45% by weight of methyl methacrylate, 25% by weight of n-butyl acrylate, and 30% by weight of methacrylic acid monomer constituting the exterior of the composite particles (having a weight average molecular weight (M_{w}) of 168,000 g/mol, and a glass transition temperature (T_{g}) of 81.6° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic polymer of 80:20).

Preparation Example 9: Preparation of composite particles with a 90:10 weight ratio of polytetrafluoroethylene and an acrylic polymer

Except that 1147.5 g of polytetrafluoroethylene aqueous dispersion and 1807.7 g of distilled water were used, and a mixed monomer of 61.2 g of methyl methacrylate and 15.3 g of n-butyl acrylate, and 0.38 g of initiator ammonium persulfate and 0.11 g of chain mover n-octylmercaptan were applied, the same method as Preparation Example 1 was used.

In the manner described above, an acrylic polymer polymerized with 80% by weight of methyl methacrylate and 20% by weight of n-butyl acrylate monomer constituting the exterior of the composite particles (having a weight average molecular weight (M_{w}) of 185,000 g/mol, and a glass transition temperature (T_{g}) of 80.1° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic-based polymer of 90:10).

### Preparation Example 10: Preparation of Composite Particles With a 70:30 Weight Ratio of polytetrafluoroethylene and an acrylic Polymer

Except that 892.5 g of polytetrafluoroethylene aqueous dispersion and 1879.1 g of distilled water were used, and a mixed monomer of 183.6 g of methyl methacrylate and 45.9 g of n-butyl acrylate, and 1.15 g of initiator ammonium persulfate and 0.32 g of chain mover n-octylmercaptan were applied, the same method as Preparation Example 1 was used.

In the manner described above, an acrylic polymer polymerized with 80% by weight of methyl methacrylate and 20% by weight of n-butyl acrylate monomer constituting the exterior of the composite particles (having a weight average molecular weight (M_{w}) of 183,000 g/mol, and a glass transition temperature (T_{g}) of 79.9° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic-based polymer of 70:30).

### Preparation Example 11: Preparation of Composite Particles With a 50:50 weight Ratio of polytetrafluoroethylene and an acrylic Polymer

Except that 637.5 g of polytetrafluoroethylene aqueous dispersion and 1950.5 g of distilled water were used, and a mixed monomer of 306.0 g of methyl methacrylate and 76.5 g of n-butyl acrylate, and 1.91 g of initiator ammonium persulfate and 0.54 g of chain mover n-octylmercaptan were applied, the same method as Preparation Example 1 was used.

In the manner described above, an acrylic polymer polymerized with 80% by weight of methyl methacrylate and 20% by weight of n-butyl acrylate monomer constituting the exterior of the composite particles (having a weight average molecular weight (M_{w}) of 180,000 g/mol, and a glass transition temperature (T_{g}) of 80.5° C.) was coated on polytetrafluoroethylene, the same material constituting the interior of the composite particles as in Preparation Example 1, to prepare composite particles (having an average diameter of the particles of 0.3 μm, and a weight ratio of polytetrafluoroethylene and the acrylic-based polymer of 50:50).

### Preparation Example 12: Preparation of Composite Particles of polytetrafluoroethylene (Standard Specific Gravity (SSG): 2.31) and an acrylic Polymer in a Weight Ratio of 80:20

Except that a polytetrafluoroethylene aqueous dispersion (manufactured by Chemours) with an average particle diameter of 0.22 μm, a solids concentration of 60%, and a standardized specific gravity (SSG) of 2.31 after sintering was applied, the same method as Preparation Example 1 was used.

In the manner described above, an acrylic polymer polymerized with 100% by weight of methyl methacrylate monomer constituting the exterior of the composite particles (having a weight average molecular weight (M_{w}) of 505,000 g/mol, and a glass transition temperature (T_{g}) of 121.0° C.) was coated on polytetrafluoroethylene, the material constituting the interior of the composite particles, to prepare composite particles having an average diameter of 0.3 μm. The weight ratio of polytetrafluoroethylene and acrylic polymer in the prepared composite particles was 80:20.

### Example (Electrodes With Composite Particles)

### Example 1: Using the Composite Particles of Preparation Example 1

95.5% by weight of the positive electrode active material NCM particle powder (GL80 manufactured by LG Chem) with an average particle diameter of 10 μm, 1.5% by weight of the conductive material (Li-250 manufactured by Denka), and 3.0% by weight of the composite particles of Preparation Example 1 as a binder were prepared. The prepared electrode active material, the conductive material, and the binder were mixed using a Lab Blender (manufactured by Waring) at 10,000 RPM, repeatedly 10 times for 30 seconds each, to prepare a mixture for dry electrodes. The mixture underwent high shear mixing for 5 minutes at 100° C., while applied with shear force at 100 RPM through a Twin Screw Kneader equipment (manufactured by Irie Shokai) to proceed with the fiberization under heating conditions. Next, the secondary mixture in the form of dough was prepared using a Two Roll Mill equipment (manufactured by Inoue) at 100° C. to produce a 200 μm thick free-standing film.

### Example 2: Using the Composite Particles of Preparation Example 2

The electrodes were prepared in the same way as in Example 1, except that the composite particles of Preparation Example 2 were used as a binder.

### Example 3: Using the Composite Particles of Preparation Example 3

The electrodes were prepared in the same way as in Example 1, except that the composite particles of Preparation Example 3 were used as a binder.

### Example 4: Using the Composite Particles of Preparation Example 4

The electrodes were prepared in the same way as in Example 1, except that the composite particles of Preparation Example 4 were used as a binder.

### Example 5: Using the Composite Particles of Preparation Example 5

The electrodes were prepared in the same way as in Example 1, except that the composite particles of Preparation Example 5 were used as a binder.

### Example 6: Using the Composite Particles of Preparation Example 6

The electrodes were prepared in the same way as in Example 1, except that the composite particles of Preparation Example 6 were used as a binder.

### Example 7: Using the composite particles of Preparation Example 7

The electrodes were prepared in the same way as in Example 1, except that the composite particles of Preparation Example 7 were used as a binder.

### Example 8: Using the Composite Particles of Preparation Example 8

The electrodes were prepared in the same way as in Example 1, except that the composite particles of Preparation Example 8 were used as a binder.

### Example 9: Using the Composite Particles of Preparation Example 3 (Binder Content: 1.5% by Weight)

The electrodes were prepared in the same way as in Example 3, except that the electrode active material was adjusted to be comprised in an amount of 95.5% by weight, the conductive material was adjusted to be comprised in an amount of 1.5% by weight, and the binder was adjusted to be comprised in an amount of 1.5% by weight.

### Example 10: Using the Composite Particles of Preparation Example 9

The electrodes were prepared in the same way as in Example 1, except that the composite particles of Preparation Example 9 were used as a binder.

### Example 11: Using the Composite Particles of Preparation Example 10

The electrodes were prepared in the same way as in Example 1, except that the composite particles of Preparation Example 10 were used as a binder.

### Comparative Example 1: Using the Composite Particles of Preparation Example 11

The electrodes were prepared in the same way as in Example 1, except that the composite particles of Preparation Example 11 were used as a binder.

### Comparative Example 2: Using polytetrafluoroethylene Particles

The electrodes were prepared in the same way as in Example 1, except that the composite particles of Preparation Example 12 were used as a binder.

### Comparative Example 3: Using polytetrafluoroethylene Particles (Binder Content: 1.5% by Weight)

The electrodes were prepared in the same way as in Example 3, except that the electrode active material was adjusted to be comprised in an amount of 97.0% by weight, the conductive material was adjusted to be comprised in an amount of 1.5% by weight, and the binder was adjusted to be present in an amount of 1.5% by weight.

### Comparative Example 4: Using polytetrafluoroethylene Particles (Mixed at Room Temperature)

The electrodes were prepared in the same way as in Example 3, except that the prepared electrode active material, the conductive material and the binder were mixed at room temperature.

### Experimental Example (Evaluation on Electrodes)

Experimental Example 1: Evaluation of Thickness Variation and Tensile Strength of Free-Standing Film-Like Electrodes

The free-standing film-like electrodes prepared according to Examples 1 to 11 and Comparative Examples 1 to 4 were sampled to a width of 20 mm, a length of 20 mm, and a thickness of 200 μm, and the thickness deviation and tensile strength of the samples were measured. The thickness deviation was measured using an electrode thickness measurement device (Millimar manufactured by Mahr), and the tensile strength was measured using UTM equipment (manufactured by LLOYD). The tensile strength is the maximum value of the force applied to the film at an angle of 180 degrees and a speed of 50 mm/min to the point where no breakage occurs. The results for the thickness deviation and tensile strength are shown in Table 1 below.

TABLE 1

| | Thickness Deviation | Tensile Strength |
|---|---|---|
| Electrodes | (%) | (gf/cm)² |
| Example 1 | ±0.4 | 2485 |
| Example 2 | ±0.4 | 2597 |
| Example 3 | ±0.4 | 2629 |
| Example 4 | ±0.5 | 2653 |
| Example 5 | ±0.5 | 2498 |
| Example 6 | ±0.5 | 2546 |
| Example 7 | ±0.5 | 2601 |
| Example 8 | ±0.6 | 2712 |
| Example 9 | ±0.3 | 2467 |
| Example 10 | ±0.5 | 2732 |
| Example 11 | ±0.4 | 2425 |
| Comparative | ±0.3 | 2148 |
| Example 1 | | |
| Comparative | ±8.8 | 1983 |
| Example 2 | | |
| Comparative | ±6.2 | 1746 |
| Example 3 | | |
| Comparative | ±10.4 | 1631 |
| Example 4 | | |

According to Table 1 above, the electrodes according to Examples 1 to 11 had a small thickness deviation and a tensile strength of more than 2,400 gf/cm², which was found to be a good physical property. On the other hand, the electrodes according to Comparative Examples 1 to 4 had a tensile strength of 2,200 gf/cm² or less, which was found to be an insufficient physical property. In addition, polytetrafluoroethylene with a high standard specific gravity (SSG) of 2.31 was found to have a significantly larger thickness variation in the electrodes according to Comparative Examples 2 to 4.

### Experimental Example 2: Evaluation the Performance of a Battery Applied With Electrodes

After preparing a 200 μm thick free-standing film according to Examples 1 to 11 and Comparative Examples 1 to 5, the free-standing film was placed on one side of a 20 μm thick Primer Coated Aluminum Foil (manufactured by Dongwon Systems) current collector, and the positive electrode was prepared by bonding through a lamination roll maintained at 120° C. Lithium metal was used as the counter electrode, and an electrolyte containing 1 M of LiPF₆ was added to a solvent of EC:DMC:DEC (having a volume ratio of 1:2:1) to prepare the half battery.

After the manufactured coin half battery was subjected to 100 charge and discharge cycles at 25° C. under the voltage range of 3 to 4.3V and current condition of 0.33 C-rate, the capacity retention ratio of 100 discharges to one discharge was calculated, and the results are shown in Table 2 below.

TABLE 2

| | 0.33 C/0.33 C |
|---|---|
| | Life at Room Temperature |
| | (Capa. Efficiency, |
| Electrodes | % @ 100th cycle) |
| Example 1 | 96.5 |
| Example 2 | 97.1 |
| Example 3 | 97.4 |
| Example 4 | 96.9 |
| Example 5 | 96.1 |
| Example 6 | 96.3 |
| Example 7 | 96.6 |
| Example 8 | 97.1 |
| Example 9 | 96.5 |
| Example 10 | 97.1 |
| Example 11 | 95.4 |
| Comparative | 93.9 |
| Example 1 | |
| Comparative | 94.6 |
| Example 2 | |
| Comparative | 93.1 |
| Example 3 | |
| Comparative | 91.8 |
| Example 4 | |

According to Table 2 above, the electrodes according to Examples 1 to 11 have a capacity retention rate of more than 95 for 100 discharges, which is an improvement over the electrodes according to Comparative Examples 1 to 4, which have a capacity retention rate of less than 95.

All simple variations or modifications of the present invention fall within the scope of the present invention, and the specific scope of protection of the present invention is clarified by the appended claims.

1. A binder comprising composite particles with a polytetrafluoroethylene structure coated with an acrylic polymer.

2. The binder according to claim 1, wherein the composite particles have an average diameter of 0.01 μm to 2 μm.

3. The binder according to claim 1, wherein the acrylic polymer is a polymer of monomers comprising alkyl acrylate, alkyl methacrylate or a combination thereof, and the alkyl is an alkyl having 1 to 10 carbon atoms.

4. The binder according to claim 1, wherein the acrylic polymer has a glass transition temperature of 60° C. to 150° C.

5. The binder according to claim 1, wherein the acrylic polymer has a weight average molecular weight of 10,000 g/mol to 300,000 g/mol.

6. The binder according to claim 3, wherein the acrylic polymer is a copolymer of monomers comprising 40% to 90% by weight of methyl methacrylate, based on the total weight of the monomers.

7. The binder according to claim 6, wherein the acrylic polymer is a copolymer of monomers comprising methyl methacrylate and n-butyl acrylate.

8. The binder according to claim 1, wherein the acrylic polymer is coated on the polytetrafluoroethylene in an amount of 5% to 40% by weight, based on the total weight of the composite particles.

9. The binder according to claim 7, wherein the n-butyl acrylate is comprised in an amount of 10 parts to 60 parts by weight, based on 100 parts by weight of methyl methacrylate.

10. The binder according to claim 6, wherein the monomer further comprises an acrylic acid or a methacrylic acid.

11. The binder according to claim 10, wherein the acrylic acid or methacrylic acid is comprised in an amount of 0.1% to 40% by weight, based on the total weight of the monomers.

12. The binder according to claim 1, wherein the polytetrafluoroethylene has a standard specific gravity (SSG) of 2.3 or less.

13. An electrode comprising the binder according to claim 1, an electrode active material and a conductive material.

14. The electrode according to claim 13, wherein the binder is present in an amount of 0.1% to 10% by weight in the electrode, based on the total weight of the binder, the electrode active material, and the conductive material.
